(19) United States
(12) Patent Application Publication
(10) Pub. No.: US 2024/0239403 A1
(43) Pub. Date: Jul. 18, 2024

(54) APPARATUS FOR CONTROLLING MOTOR DRIVEN POWER STEERING SYSTEM OF VEHICLE AND METHOD THEREOF

(71) Applicant: HYUNDAI MOBIS CO., LTD., Seoul (KR)

(72) Inventor: Tae Hong KIM, Yongin-si (KR)

(73) Assignee: HYUNDAI MOBIS CO., LTD., Seoul (KR)

(21) Appl. No.: 18/383,783

(22) Filed: Oct. 25, 2023

(30) Foreign Application Priority Data
Jan. 18, 2023 (KR) 10-2023-0007328

(51) Int. Cl. B62D 5/04; B60W 60/00

(52) U.S. Cl. CPC B62D 5/046; B60W 60/001; B60W 2710/20

(57) ABSTRACT

An apparatus for controlling a motor driven power steering system of a vehicle and a method thereof are disclosed. The apparatus includes: first and second memories configured to store execution programs therein; and first and second processors operatively coupled to the first and second memories, respectively, wherein the first and second processors are configured to: receive an input of a command steering angle from an upper level system by driving the execution programs, calculate a command current for a position control by receiving a feedback of sensing results from first and second sensing modules configured to sense respective operation states of first and second driving motors for steering vehicle wheels, and drive the first and second driving motors by compensating for the command current after exchanging compensation information by an output limit rate through first and second communication modules.

### CROSS-REFERENCE TO RELATED APPLICATION

This application claims priority from and the benefit of Korean Patent Application No. 10-2023-0007328, filed on Jan. 18, 2023, which is hereby incorporated by reference for all purposes as if set forth herein.

### BACKGROUND

### Field

Exemplary embodiments of the present disclosure relate to an apparatus for controlling a motor driven power steering system of a vehicle and a method thereof, and more particularly, to an apparatus for controlling a motor driven power steering system of a vehicle and a method thereof, which can maintain a control performance by correcting an output in a normal system in case that any one output is limited in a motor driven power steering system having a redundancy structure for an autonomous vehicle.

### Discussion of the Background

In general, a steering system is provided in a vehicle in a manner that a steering wheel is installed in front of a driver's seat in the vehicle, and a steering shaft is connected to a rotary shaft of the steering wheel, so that as a driver rotates the steering wheel, the rotary shaft of the steering wheel is rotated to rotate the steering shaft, and thus front wheels of the vehicle turn left and right to change the driving direction of the vehicle.

In such a steering system, if a rotation force for the driver to rotate the steering wheel is directly transferred to the steering shaft for steering, a lot of strength is required for the driver to rotate the steering wheel.

Therefore, in order to relieve the required force during the driver's steering operation, a hydraulic steering system using a hydraulic actuator during the operation of the steering wheel has been commercialized.

Meanwhile, motor driven power steering (MDPS) has recently been applied in a manner that a motorized actuator is installed in a steering system of a vehicle, and as a driver rotates the steering wheel, the motorized actuator is driven to make the front wheels of the vehicle turn left and right, and thus to change the driving direction of the vehicle.

The motorized steering device as described above is provided with a torque sensor configured to measure a driver's steering torque being input to the steering wheel, a steering angle sensor configured to measure a steering angle of the steering wheel, and a vehicle speed sensor configured to measure a vehicle speed, and is configured to perform steering by adjusting current being supplied to a drive actuator, such as a motor, through judgment of a driving condition of the vehicle.

The related art of the present disclosure is disclosed in Korean Patent Application Publication No. 10-2011-0007766 (published on Jan. 25, 2011, entitled “MOTOR RELAY CONTROL APPARATUS AND METHOD IN MOTOR DRIVEN POWER STEERING SYSTEM”).

### SUMMARY

Recently, in order to prevent a control blank from occurring in a vehicle without driver intervention, such as an autonomous vehicle, and to secure driver's safety through continuous maintaining of a steering force even if the vehicle breaks down, technology for a control device of a motor driven power steering system to which a redundant system (i.e., fully redundant system) is applied has been researched.

The motor driven power steering system having the redundant structure as described above operates in a manner that even if one side of the system breaks down, the other side thereof can continuously maintain the output, but the system has a problem in that the overall output is decreased in case that the output of either side is limited due to a temperature or voltage problem.

The present disclosure has been devised to solve the above-described problems, and an object of the present disclosure is to provide an apparatus for controlling a motor driven power steering system of a vehicle and a method thereof, which can maintain the control performance by correcting an output in a normal system in case that any one output is limited in the motor driven power steering system having a redundant structure for an autonomous vehicle.

According to an embodiment of the present disclosure, an apparatus for controlling a motor driven power steering system of a vehicle includes: a first memory and a second memory configured to store execution programs therein; and a first processor and a second processor operatively coupled to the first memory and the second memory, respectively, wherein the first processor and the second processor are configured to: receive an input of a command steering angle from an upper level system by driving the respective execution programs, calculate a command current for a position control by receiving a feedback of sensing results from a first sensing module and a second sensing module configured to sense respective operation states of a first driving motor and a second driving motor for steering vehicle wheels, and drive the first driving motor and the second driving motor by compensating for the command current after exchanging compensation information by an output limit rate through a first communication module and a second communication module.

In the present disclosure, the first processor and the second processor are configured to compensate for the command current by receiving an input of the compensation information based on the output limit rate from one of the first processor and the second processor if the other thereof is in a normal state.

In the present disclosure, the first processor and the second processor are configured not to exchange the compensation information based on the output limit rate if the first processor and the second processor are not in a normal state.

In the present disclosure, the first processor and the second processor are respectively configured to provide the command current being limited based on the output limit rate as the compensation information based on the output limit rate.

In the present disclosure, the first processor and the second processor are respectively configured to receive an input of the command steering angle from an autonomous driving system that is the upper level system.

According to another aspect of the present disclosure, a method for controlling a motor driven power steering system of a vehicle includes: receiving, by a first processor and a second processor, an input of a command steering angle from an upper level system, and receiving a feedback of sensing results from a first sensing module and a second sensing module that sense respective operation states of a first driving motor and a second driving motor; calculating, by the first processor and the second processor, a command current based on the command steering angle and the sensing results; exchanging, by the first processor and the second processor, compensation information by an output limit rate by judging whether the first processor and the second processor are in a normal state, respectively; compensating, by any one of the first processor and the second processor, for the command current based on the compensation information based on the output limit rate; and performing, by the first processor and the second processor, a position control by driving the first driving motor and the second driving motor based on the command current.

In the present disclosure, the exchanging of the compensation information based on the output limit rate receives an input of the compensation information based on the output limit rate from one of the first processor and the second processor if the other thereof is in a normal state.

In the present disclosure, the exchanging of the compensation information based on the output limit rate does not exchange the compensation information based on the output limit rate if the first processor and the second processor are not in a normal state.

In the present disclosure, the exchanging of the compensation information based on the output limit rate provides, by the first processor and the second processor, the command current being limited based on the output limit rate as the compensation information based on the output limit rate.

The apparatus for controlling a motor driven power steering system of a vehicle and a method thereof according to an aspect of the present disclosure can maintain the control performance by correcting an output in a normal system in case that any one output is limited in the motor driven power steering system having a redundant structure for an autonomous vehicle, and thus it is possible to prevent the control performance deterioration that occurs due to an offset or deviation for signals based on the redundant structure, and to perform the best control even in case that an output limit occurs due to an external hardwired cause.

### BRIEF DESCRIPTION OF THE DRAWINGS

FIG. 1 is a block diagram illustrating an apparatus for controlling a motor driven power steering system of a vehicle according to an embodiment of the present disclosure.

FIG. 2 is a flowchart explaining a method for controlling a motor driven power steering system of a vehicle according to an embodiment of the present disclosure.

### DETAILED DESCRIPTION OF THE ILLUSTRATED EMBODIMENTS

Hereinafter, an apparatus for controlling a motor driven power steering system of a vehicle and a method thereof according to the present disclosure will be described with reference to the accompanying drawings. In this process, it should be considered that the thickness of each line or the size of each component in the drawings may be exaggeratedly illustrated for clarity and convenience of description. In addition, the terms used herein are terms defined in consideration of functions of the present disclosure, and these terms may change depending on the intention or practice of a user or an operator. Therefore, these terms should be defined based on the entirety of the disclosure set forth herein.

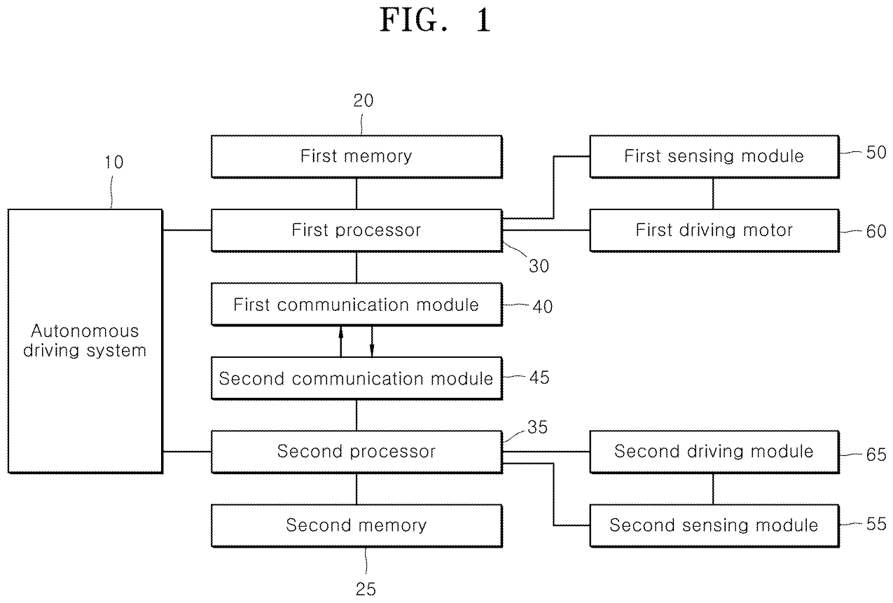

FIG. 1 is a block diagram illustrating an apparatus for controlling a motor driven power steering system of a vehicle according to an embodiment of the present disclosure.

As illustrated in FIG. 1, an apparatus for controlling a motor driven power steering system of a vehicle according to an embodiment of the present disclosure may include a first driving motor 60 and a second driving motor 65, a first sensing module 50 and a second sensing module 55, a first communication module 40 and a second communication module 45, a first memory 20 and a second memory 25, and a first processor 30 and a second processor 35.

The first driving motor 60 and the second driving motor 65 are driven through a command current, and steer vehicle wheels, respectively.

Here, the first driving motor 60 and the second driving motor 65 are driven to provide a 100% output through summing of 50% outputs thereof.

The first sensing module 50 and the second sensing module 55 may get a feedback of a current steering angle, a current steering angular speed, and a current driving current by sensing the operation states of the first driving motor 60 and the second driving motor 65.

The first communication module 40 and the second communication module 45 may connect to an internal communication network of the vehicle, and may mutually transmit data being output from the first processor 30 and the second processor 35 to share the data with each other.

The first memory 20 and the second memory 25 may store therein execution programs for an operation of the motor driven power steering system and related data, and if necessary, the stored information may be independently taken and selected by the first processor 30 and the second processor 35.

That is, the first memory 20 and the second memory 25 store therein the operating system for driving the motor driven power steering system or various kinds of data being generated in a process of executing an application (program or applet). In this case, the first memory 20 and the second memory 25 commonly call a nonvolatile storage device that continuously maintains the stored information even if a power is not supplied thereto and a volatile storage device that requires the power to maintain the stored information. Further, the first memory 20 and the second memory 25 may temporarily or permanently store the data being processed by the first processor 30 and the second processor 35.

Here, in order to maintain the stored information, the first memory 20 and the second memory 25 may include magnetic storage media or flash storage media in addition to the volatile storage device that requires the power, but the scope of the present disclosure is not limited thereto.

The first processor 30 and the second processor 35 may be operatively coupled to the first driving motor 60 and the second driving motor 65, the first sensing module 50 and the second sensing module 55, the first communication module 40 and the second communication module 45, and the first memory 20 and the second memory 25, respectively, and may be configured to control the overall operation of the motor driven power steering system, and may be implemented by an integrated circuit or a system.

The first processor 30 and the second processor 35 may receive an input of a command steering angle from an autonomous driving system 10 that is an upper level system by driving execution programs stored in the first memory 20 and the second memory 25, calculate a command current for a position control by receiving a feedback of sensing results from the first sensing module 50 and the second sensing module 55 that sense the operation states of the first driving motor 60 and the second driving motor 65 that steer vehicle wheels, and drive the first driving motor 60 and the second driving motor 65 by compensating for the command current after exchanging compensation information by an output limit rate through the first communication module 40 and the second communication module 45.

Here, the output limit rate may be set to prevent the temperature increase through reduction of the output to protect the system if a problem arises in the motor driven power steering system, such as the temperature increases, the voltage drops, or the current usage amount exceeds a set value. In this case, the system can be protected by limiting the output through multiplication of the command current based on the output limit rate.

For example, if the temperature rises too much, and the system overload occurs, the temperature increase can be prevented by providing only the 50% output through multiplication of the calculated command current based on the output limit rate of 0.5.

Accordingly, if one side limits the output to 50% based on the output limit rate of 0.5, the other side compensates for the output by 150% through mutual exchange of the compensation information based on the output limit rate, and thus the 100% output can be maintained through summation of the both outputs.

Here, if any one of the first processor 30 and the second processor 35 is in a normal state, it may compensate for the command current by receiving an input of the compensation information based on the output limit rate from the other thereof.

Further, if the first processor 30 and the second processor 35 are not in a normal state, they may not exchange the compensation information based on the output limit rate with each other. Further, even if they exchange the compensation information based on the output limit rate, they may not compensate for the output through reflection of this.

This is because the system damage may occur if the output is increased to compensate for the output of the relative control system in a state where the output limit rate is set to protect the system.

As described above, in case that any one of the first processor 30 and the second processor 35 provides the command current that is limited based on the output limit rate as the compensation information based on the output limit rate, the other thereof may compensate for and output the command current by increasing the same as much as the command current that is limited according to the compensation information based on the output limit rate, and thus the output may be constantly maintained.

As described above, according to the apparatus for controlling a motor driven power steering system of a vehicle according to an embodiment of the present disclosure, in case that any one output is limited in the motor driven power steering system having a redundant structure for an autonomous vehicle, a normal system maintains the control performance by correcting the output, and thus it is possible to prevent the control performance deterioration that occurs due to an offset or deviation for signals based on the redundant structure, and to perform the best control even in case that an output limit occurs due to an external hardwired cause.

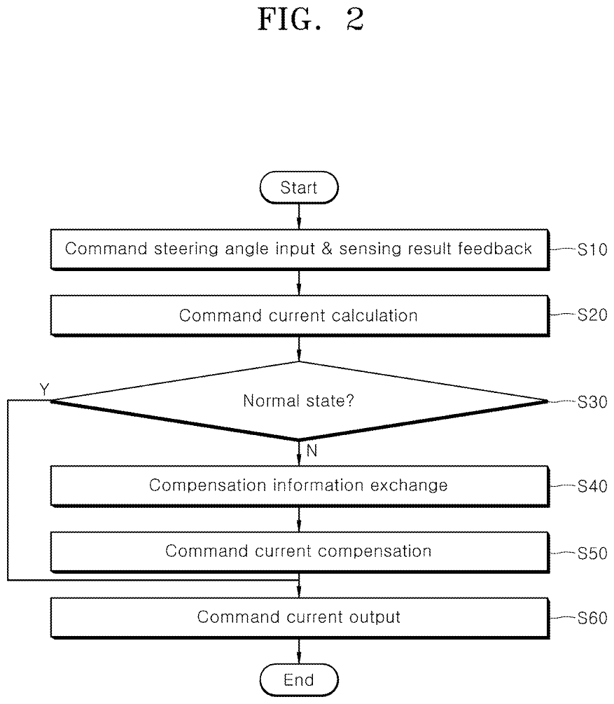

FIG. 2 is a flowchart explaining a method for controlling a motor driven power steering system of a vehicle according to an embodiment of the present disclosure.

As illustrated in FIG. 2, according to a method for controlling a motor driven power steering system of a vehicle according to an embodiment of the present disclosure, the first processor 30 and the second processor 35 first receive an input of a command steering angle from an autonomous driving system 10 that is an upper level system after driving execution programs stored in the first memory 20 and the second memory 25, and receive a feedback of sensing results from the first sensing module 50 and the second sensing module 55 that sense respective operation states of the first driving motor 60 and the second driving motor 65 (S10).

Here, the first processor 30 and the second processor 35 may receive a feedback of a current steering angle, a current steering angular speed, and a current driving current obtained by sensing the operation states of the first driving motor 60 and the second driving motor 65 from the first sensing module 50 and the second sensing module 55.

Accordingly, the first processor 30 and the second processor 35 may calculate the command current based on the feedback results of the current steering angle, the current steering angular speed, and the current driving current obtained through sensing of the command steering angle and the operation states of the driving motors in step S10 (S20).

After calculating the command current in step S20, the first processor 30 and the second processor 35 judge whether they are in a normal state, respectively (S30).

That is, the first processor 30 and the second processor 35 may judge whether the output limit rate has been set.

Accordingly, if they are all in the normal state through the judgment in step S30, the first processor 30 and the second processor 35 may perform the position control by driving the first driving motor 60 and the second driving motor 65 through output of the calculated command current.

In contrast, if they are not in the normal state through the judgment in step S30, the first processor 30 and the second processor 35 may limit the command current by multiplying the calculated command current based on the output limit rate in case that the output limit rate is set for the system protection.

Further, the first processor 30 and the second processor 35 exchange the compensation information based on the output limit rate with each other in order to compensate for the limited command current (S40).

Here, the output limit rate may be set to prevent the temperature increase through reduction of the output to protect the system if a problem arises in the motor driven power steering system, such as the temperature increases, the voltage drops, or the current usage amount exceeds a set value. In this case, the system can be protected by limiting the output through multiplication of the command current based on the output limit rate.

In this case, if any one of the first processor 30 and the second processor 35 is in a normal state, it may compensate for the command current by receiving an input of the compensation information based on the output limit rate from the other thereof.

However, if the first processor 30 and the second processor 35 are not in a normal state, they may not exchange the compensation information based on the output limit rate with each other. Further, even if they exchange the compensation information based on the output limit rate, they may not compensate for the output through reflection of this.

In step S40, if any one of the first processor 30 and the second processor 35 provides the command current that is limited based on the output limit rate as the compensation information based on the output limit rate, the other thereof may compensate for the command current by increasing the same as much as the command current that is limited according to the compensation information based on the output limit rate.

After compensating for the command current in step S50, the first processor 30 and the second processor 35 may perform the position control by driving the first driving motor 60 and the second driving motor 65 through output of the calculated command current (S60).

As described above, according to the method for controlling a motor driven power steering system of a vehicle according to an embodiment of the present disclosure, in case that any one output is limited in the motor driven power steering system having a redundant structure for an autonomous vehicle, a normal system maintains the control performance by correcting the output, and thus it is possible to prevent the control performance deterioration that occurs due to an offset or deviation for signals based on the redundant structure, and to perform the best control even in case that an output limit occurs due to an external hardwired cause.

Implementations as described in the specification may be performed by, for example, a method or a process, a device, a software program, a data stream, or a signal. Although being discussed only in context of implementation in a single form (e.g., being discussed only in method), the discussed features can be implemented also in another form (e.g., device or program). The device may be implemented by proper hardware, software, and firmware. The method may be implemented by, for example, a device, such as a processor generally calling a processing device including a computer, a microprocessor, an integrated circuit, or a programmable logic device. The processor includes a communication device, such as a computer, a cell phone, a portable/personal information terminal (personal digital assistant (PDA)), which facilitates information communication between end-users and other devices.

Although the present disclosure has been described with reference to the embodiment illustrated in the drawings, this is merely exemplary, and those of ordinary skill in the art to which the present disclosure pertains will appreciate that various modifications and other equivalent embodiments are possible therefrom.

Therefore, the true technical scope of the disclosure should be defined by the following claims.

What is claimed is:

1. An apparatus for controlling a motor driven power steering system of a vehicle, the apparatus comprising:
a first memory and a second memory configured to store execution programs therein; and
a first processor and a second processor operatively coupled to the first memory and the second memory, respectively,
wherein the execution programs stored in the first memory and the second memory, when respectively executed by the first processor and the second processor, cause the first processor and the second processor to:
receive an input of a command steering angle from an upper level system,
calculate a command current for a position control based on a feedback of sensing results from a first sensing module and a second sensing module configured to sense respective operation states of a first driving motor and a second driving motor for steering vehicle wheels, and
drive the first driving motor and the second driving motor by compensating for the command current after exchanging compensation information by an output limit rate through a first communication module and a second communication module.

2. The apparatus according to claim 1, wherein the execution programs stored in the first memory and the second memory, when respectively executed by the first processor and the second processor, further cause the first processor and the second processor to compensate for the command current by receiving an input of the compensation information based on the output limit rate from one of the first processor and the second processor if another of the first processor and the second processor is in a normal state.

3. The apparatus according to claim 1, wherein the execution programs stored in the first memory and the second memory, when respectively executed by the first processor and the second processor, further cause the first processor and the second processor not to exchange the compensation information based on the output limit rate if the first processor and the second processor are not in a normal state.

4. The apparatus according to claim 1, wherein the execution programs stored in the first memory and the second memory, when respectively executed by the first processor and the second processor, further cause the first processor and the second processor to provide the command current being limited based on the output limit rate as the compensation information based on the output limit rate.

5. The apparatus according to claim 1, wherein the execution programs stored in the first memory and the second memory, when respectively executed by the first processor and the second processor, respectively cause the first processor and the second processor to receive an input of the command steering angle from an autonomous driving system that is the upper level system.

6. A method for controlling a motor driven power steering system of a vehicle, the method comprising:
receiving, by a first processor and a second processor, an input of a command steering angle from an upper level system, and receiving a feedback of sensing results from a first sensing module and a second sensing module that sense respective operation states of a first driving motor and a second driving motor;
calculating, by the first processor and the second processor, a command current based on the command steering angle and the sensing results;
exchanging, by the first processor and the second processor, compensation information by an output limit rate by judging whether the first processor and the second processor are in a normal state, respectively;
compensating, by one of the first processor and the second processor, for the command current based on the compensation information based on the output limit rate; and
performing, by the first processor and the second processor, a position control by driving the first driving motor and the second driving motor based on the command current.

7. The method according to claim 6, wherein the exchanging of the compensation information based on the output limit rate includes receiving an input of the compensation information based on the output limit rate from one of the first processor and the second processor if another of the first processor and the second processor is in a normal state.

8. The method according to claim 6, wherein the exchanging of the compensation information based on the output limit rate does not include exchanging the compensation information based on the output limit rate if the first processor and the second processor are not in a normal state.

9. The method according to claim 6, wherein the exchanging of the compensation information based on the output limit rate includes providing, by the first processor and the second processor, the command current being limited based on the output limit rate as the compensation information based on the output limit rate.

10. The method according to claim 6, wherein the upper level system includes an autonomous driving system.
